(19) United States
(12) Patent Application Publication
(10) Pub. No.: US 2011/0305158 A1
(43) Pub. Date: Dec. 15, 2011

(54) METHOD AND APPARATUS FOR TRANSMITTING/RECEIVING MULTICAST RESOURCE ALLOCATION INFORMATION IN COMMUNICATION SYSTEM

(75) Inventors: Se-Ho KIM, Seoul (KR); Hee-Won KANG, Seongnam-si (KR)

(73) Assignee: SAMSUNG ELECTRONICS CO. LTD., Suwon-si (KR)

(21) Appl. No.: 13/156,590

(22) Filed: Jun. 9, 2011

(30) Foreign Application Priority Data
Jun. 11, 2010 (KR) 10-2010-0055380

(51) Int. Cl. H04W 4/06; H04W 24/00; H04W 72/04

(52) U.S. Cl. 370/252; 370/312; 370/280

(57) ABSTRACT

A method and an apparatus for transmitting and receiving multicast resource allocation information in a communication system are provided. In the communication system, a base station transmits the multicast resource allocation information to a mobile station, wherein the multicast resource allocation information includes a Group IDentifier (ID) of a group which should receive multicast resource allocation information on multicast resources through which a multicast data burst is to be transmitted, a Resource Index indicating a location and a size of allocated multicast resources, and a Long Transmission Time Interval Indicator (Long_TTI_Indicator) indicating a number of Advanced Air Interface (AAI) subframes spanned by the allocated multicast resources.

### PRIORITY

This application claims the benefit under 35 U.S.C. §119(a) to a Korean patent application filed in the Korean Intellectual Property Office on Jun. 11, 2010 and assigned Serial No. 10-2010-0055380, the entire disclosure of which is hereby incorporated by reference.

### BACKGROUND OF THE INVENTION

1. Field of the Invention

The present invention relates to a method and an apparatus for at least one of transmitting and receiving multicast resource allocation information in a communication system.

2. Description of the Related Art

Next generation communication systems are continuously developing with respect to providing various high-speed large scale services to Mobile Stations (MSs). An Institute of Electrical and Electronics Engineers (IEEE) 802.16 communication system and a Mobile Worldwide Interoperability for Microwave Access (WiMAX) communication system are representative of the next generation communication systems.

Also, an example of the IEEE 802.16 communication systems is an IEEE 802.16m communication system. In the IEEE 802.16m communication system, a Base Station (BS) allocates resources to each of the MSs, and transmits a resource allocation Information Element (IE), which is resource allocation information on the resources allocated to each of the MSs, to each of the MSs by using a MAP message. The resource allocation IE includes information on a location and a size of the resources allocated to each of the MSs, information on a modulation scheme and a coding rate which is to be used for the resources allocated to each of the MSs, and other suitable information.

In the IEEE 802.16m communication system, a BS may perform data transmission according to a multicast scheme. Specifically, the BS may perform multicast data transmission by using multicast resources included in an Enhanced Multicast Broadcast Service (E-MBS) zone.

Currently, the IEEE 802.16m communication system includes a proposed multicast scheme such that multicast data may be transmitted by using multicast resources included in an E-MBS zone. However, the IEEE 802.16m communication system does not yet have a specifically proposed method for transmitting and receiving a resource allocation IE when the multicast scheme is employed.

Hence, in the IEEE 802.16m communication system, there has been an increasing need for a method for at least one of transmitting and receiving a resource allocation IE on the multicast resources.

### SUMMARY OF THE INVENTION

Aspects of the present invention are to address the above-mentioned problems and/or disadvantages and to provide the advantages described below. Accordingly, an aspect of the present invention is to provide a method and an apparatus for at least one of transmitting and receiving multicast resource allocation information in a communication system.

In accordance with an aspect of the present invention, a method for transmitting multicast resource allocation information by a base station in a communication system is provided. The method includes transmitting, to at least one mobile station, the multicast resource allocation information, wherein the multicast resource allocation information includes a Group IDentifier (ID) of a group receiving multicast resource allocation information on multicast resources through which a multicast data burst is to be transmitted, a Resource Index indicating a location and a size of allocated multicast resources, and a Long Transmission Time Interval Indicator (Long_TTI_Indicator) indicating a number of Advanced Air Interface (AAI) subframes spanned by the allocated multicast resources.

In accordance with another aspect of the present invention, a method for receiving multicast resource allocation information by a mobile station in a communication system is provided. The method includes receiving, from a base station, the multicast resource allocation information, wherein the multicast resource information includes a Group ID of a group receiving multicast resource allocation information on multicast resources through which a multicast data burst is to be transmitted, a Resource Index indicating a location and a size of allocated multicast resources, and a Long_TTI_Indicator indicating a number of AAI subframes spanned by the allocated multicast resources.

In accordance with another aspect of the present invention, a base station in a communication system is provided. The base station includes a signal generator for generating multicast resource allocation information, and a transmitter for transmitting a multicast resource allocation information. The multicast resource allocation information includes a Group ID of a group receiving multicast resource allocation information on multicast resources through which a multicast data burst is to be transmitted, a Resource Index indicating a location and a size of allocated multicast resources, and a Long_TTI_Indicator indicating a number of AAI subframes spanned by the allocated multicast resources.

In accordance with another aspect of the present invention, a mobile station in a communication system is provided. The mobile station includes a receiver for receiving multicast resource allocation information, and a resource allocation information detector for detecting the multicast resource allocation information. The multicast resource allocation information includes a ID of a group receiving multicast resource allocation information on multicast resources through which a multicast data burst is to be transmitted, a Resource Index indicating a location and a size of allocated multicast resources, and a Long_TTI_Indicator indicating a number of AAI subframes spanned by the allocated multicast resources.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will be more apparent from the following description taken in conjunction with the accompanying drawings, in which:

FIG. 1 is a block diagram illustrating an internal configuration of an Institute of Electrical and Electronics Engineers (IEEE) 802.16m communication system according to an exemplary embodiment of the present invention;

FIG. 2 is an illustrative view showing a frame structure of an IEEE 802.16m communication system according to an exemplary embodiment of the present invention;

FIG. 3 is a flowchart showing an operational process of a Base Station (BS) in an IEEE 802.16m communication system according to an exemplary embodiment of the present invention;

FIG. 4 is a flowchart showing an operational process of a Mobile Station (MS) in an IEEE 802.16m communication system according to an exemplary embodiment of the present invention;

FIG. 5 is a block diagram illustrating an internal configuration of a BS in an IEEE 802.16m communication system according to an exemplary embodiment of the present invention; and

FIG. 6 is a block diagram illustrating an internal configuration of an MS in an IEEE 802.16m communication system according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention include methods and apparatuses for at least one of transmitting and receiving multicast resource allocation information in a communication system. Hereinafter, in describing the exemplary embodiments of the present invention, a communication system is assumed to be an Institute of Electrical and Electronics Engineers (IEEE) 802.16m communication system. However, the present invention is not limited there to, and other suitable communication systems may include a method and an apparatus of the invention herein. For example, a method and an apparatus for at least one of transmitting and receiving multicast resource allocation information according to an exemplary embodiment of the present invention may be employed in a Mobile Worldwide Interoperability for Microwave Access (WiMAX) communication system, or other similar communications systems , as well as in the IEEE 802.16m communication system.

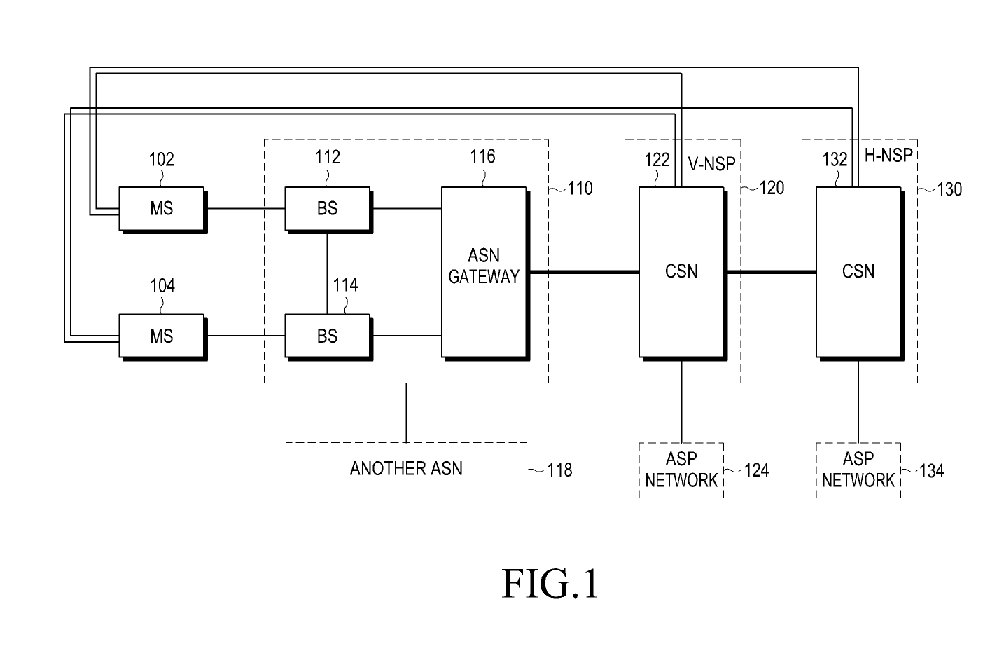

FIG. 1 is a block diagram illustrating an internal configuration of an IEEE 802.16m communication system according to an exemplary embodiment of the present invention.

Referring to FIG. 1, the IEEE 802.16m communication system includes one or more Mobile Stations (MSs) 102 and 104, one or more Access Service Networks (ASNs) 110 and 118, and one or more Connectivity Service Networks (CSNs) 122 and 132.

The CSNs 122 and 132 are included in Network Service Providers (NSPs), such as a Visited-NSP (V-NSP) 120 or a Home-NSP (H-NSP) 130, in which the relevant MSs 102 and 104 are registered. Each of the CSNs 122 and 132 can connect to Access Service Provider (ASP) networks 124 and 134, such as the Internet.

The ASN 110 includes function blocks which perform network functions for providing wireless connections to users of the MSs 102 and 104. Specifically, the ASN 110 sets a first layer connection and a second layer connection between itself and the MSs 102 and 104, and sets a third layer connection between itself and the NSPs 120 and 130. Accordingly, the ASN 110 supports the MSs 102 and 104 so that the MSs 102 and 104 can access a network, and performs wireless resource management for effective wireless communication of the MSs 102 and 104. Also, the ASN 110 provides functions for mobility management, including ASN anchored mobility, CSN anchored mobility, paging, ASN-CSN tunneling, or other similar functions. To this end, the ASN 110 includes one or more BSs 112 and 114, which connect to the MSs 102 and 104, and at least one ASN gateway 116 which connects to the NSPs 120 and 130.

Each of the CSNs 122 and 132 includes function blocks which perform network functions for providing Internet Protocol (IP) connectivity services to the users of the MSs 102 and 104. Specifically, the CSNs 122 and 132 allocate IP addresses and endpoint parameters for a user session to the MSs 102 and 104, support ASN-CSN tunneling and tunneling between CSNs, and manage mobility between ASNs.

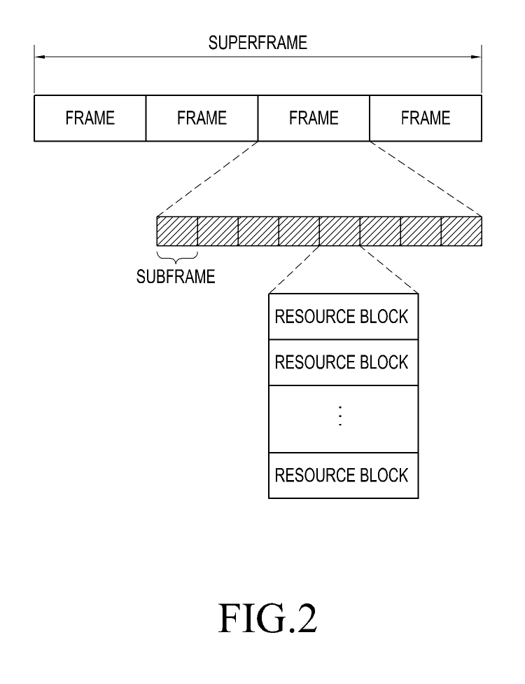

Next, a frame structure of the IEEE 802.16m communication system according to an exemplary embodiment of the present invention will be described with reference to FIG. 2.

FIG. 2 is an illustrative view showing a frame structure of the IEEE 802.16m communication system according to an exemplary embodiment of the present invention.

Referring to FIG. 2, a single superframe includes multiple frames, and each of the multiple frames includes multiple subframes. Each of the multiple subframes includes multiple Orthogonal Frequency Division Multiple Access (OFDMA) symbols.

Also, in the IEEE 802.16m communication system, resource allocation may be performed for resources in each subframe. In each of the subframes, resource allocation may be performed per Resource Block (RB). Namely, a BS allocates a number n RBs to an MS, wherein n is an integer equal to or greater than 1.

Accordingly, the BS transmits resource allocation information, i.e. a resource allocation Information Element (IE), in each subframe. In this case, each of resource allocation IEs is Cyclic Redundancy Check (CRC) masked by using a sequence allocated to an MS which should receive a relevant resource allocation IE. Then, each of the CRC-masked resource allocation IEs is transmitted to the MS. Therefore, in performing a CRC on the received resource allocation IEs by using the sequence allocated to each MS, each MS can itself determine whether the resource allocation IE should be received by itself. In this case, a scheme in which coding is performed by using a sequence allocated to each MS that should receive a resource allocation IE is called a separate coding scheme.

Meanwhile, in the IEEE 802.16m communication system, a BS may perform data transmission in a multicast scheme. In this case, the BS may perform multicast data transmission by using multicast resources included in an Enhanced Multicast Broadcast Service (E-MBS) zone.

However, in the current IEEE 802.16m communication system, proposals relating to the multicast scheme include only the transmission of multicast data performed by using multicast resources included in an E-MBS zone. Accordingly, there has been no specific proposal about a method for at least one of transmitting and receiving a resource allocation IE when the multicast scheme is employed.

Therefore, in the exemplary embodiments of the present invention a method for at least one of transmitting and receiving a multicast resource allocation IE when the IEEE 802.16m communication system employs the multicast scheme is proposed.

First, a multicast group is a group including MSs receiving the same multicast data and includes at least one MS. Hereinafter, for convenience of description, it is assumed that a single multicast group includes multiple MSs. Also, multicast groups are distinguished by group IDentifiers (IDs), so that MSs, which are included in the relevant multicast group, can receive multicast data and multicast resource allocation IEs by using the group ID. In this case, a BS may notify the MSs, which are included in the relevant multicast group, of the group ID, for example, through a Dynamic Service Addition (DSA) process. Also, it goes without saying that the BS may notify the MSs included in the relevant multicast group of the group ID through a process other than the DSA process.

After notifying the MSs of the group ID through the DSA process as described above, the BS transmits the multicast data and the multicast resource allocation IEs to the MSs by using the group ID.

Hereinafter, a format of a multicast resource allocation IE according to exemplary embodiments of the present invention will be described with reference to Table 1 below. According to the present exemplary embodiment of the present invention, the multicast resource allocation IE is a multicast Advanced-MAP (A-MAP) IE.

TABLE 1

| | Size | |
|---|---|---|
| Syntax | (bits) | Notes |
| Multicast A-MAP | | |
| IE ( ) | | |
| { | | |
| A-MAP IE Type | 4 | Multicast A-MAP IE |
| Group ID | 10 | Group ID for multicast assignment |
| | | Group ID is unique in a cell |
| I_SizeOffset | 5 | Offset used to compute burst size index |
| Resource Index | 11 | Resource index includes location and |
| | | allocation size |
| Long_TTI_Indicator | 1 | Indicates the number of AAI subframes |
| | | spanned by the allocated resources |
| | | 0b0: 1 AAI subframe (default) |
| | | 0b1: 4 DL AAI subframes for FDD or all |
| | | DL AAI subframes for TDD |
| AI_SN | 1 | HARQ identifier sequence number |
| Retransmission | 2 | Retransmission interval of next |
| Interval | | retransmission |
| | | 0b00: no retransmission |
| | | 0b01: 1 frame |
| | | 0b10: 2 frames |
| | | 0b11: 3 frames |
| ACID | 2 | HARQ channel identifier |
| SPID | 2 | HARQ subpacket identifier for HARQ IR |
| | | 0b00: 0 |
| | | 0b01: 1 |
| | | 0b10: 2 |
| | | 0b11: 3 |
| CRV | 1 | Constellation Rearrangement Version |
| Reserved | 1 | |
| } | | |

In Table 1, A-MAP IE Type represents the type of an A-MAP IE included in an A-MAP message for the transmission of the multicast resource allocation IE, and it is assumed that the A-MAP IE Type is implemented by using 4 bits. However, the present invention is not limited thereto, and other suitable numbers of bits may be used. In Table 1, the A-MAP IE Type is set to a value representing a multicast resource allocation IE, and is defined by Table 2 below.

TABLE 2

| A-MAP IE Type | Usage |
|---|---|
| 0b0000 | DL Basic Assignment A-MAP IE |
| 0b0001 | UL Basic Assignment A-MAP IE |
| 0b0010 | DL Subband Assignment A-MAP IE |
| 0b0011 | UL Subband Assignment A-MAP IE |
| 0b0100 | Feedback Allocation A-MAP IE |
| 0b0101 | UL Sounding Command A-MAP IE |
| 0b0110 | CDMA Allocation A-MAP IE |
| 0b0111 | DL Persistent Allocation A-MAP IE |
| 0b1000 | UL Persistent Allocation A-MAP IE |
| 0b1001 | Group Resource Allocation A-MAP IE |
| 0b1010 | Feedback Polling A-MAP IE |
| 0b1011 | BR-ACK A-MAP IE |
| 0b1100 | Broadcast Assignment A-MAP IE |
| 0b1101 | Multicast A-MAP IE |
| 0b1110 | Reserved |
| 0b1111 | Extended Assignment A-MAP IE |

As shown in Table 2, when the value of the A-MAP IE Type, for example, is 0b1101, the A-MAP IE Type indicates a multicast resource allocation IE (i.e. a multicast A-MAP IE).

In Table 1, Group ID represents a group ID of a group including MSs, each of which should receive a relevant multicast resource allocation IE, and for example, may be implemented by using 10 bits. In this case, the Group ID is uniquely determined in the same cell.

In Table 1, I_SizeOffset represents an offset used to compute a size index of a multicast data burst used to transmit multicast data, and for example, may be implemented by using 5 bits. By using the I_SizeOffset, it is possible to detect Modulation and Coding Scheme (MCS) level information and a size of the multicast data burst.

In Table 1, Resource Index represents the location and the size of the allocated multicast resources, and for example, may be implemented by using 11 bits. By using the Resource Index, it is possible to detect the number of locations at which the multicast resources have been allocated and the number of resource units, e.g. Resource Blocks (RBs), included in the multicast resources.

In Table 1, whether a Long Transmission Time Interval (TTI) is supported is indicated by a Long_TTI_Indicator, and for example, may be implemented by using 1 bit. When the value of the Long_TTI_Indicator is 0b0, the Long_TTI_Indicator indicates that a multicast data burst is transmitted only in the relevant subframe. When the value of Long_TTI_Indicator is 0b1, the Long_TTI_Indicator indicates that a multicast data burst is transmitted in all subframes included in a downlink. Namely, the Long_TTI_Indicator indicates the number of Advanced Air Interface (AAI) subframes spanned by the allocated multicast resources. When the value of the Long_TTI_Indicator is 0b0, the Long_TTI_Indicator indicates that the allocated multicast resources exist only in a single AAI subframe. When the value of the Long_TTI_Indicator is 0b1, the Long_TTI_Indicator indicates that the allocated multicast resources span four DownLink (DL) AAI subframes for a Frequency Division Duplexing (FDD) scheme, or indicates that the allocated multicast resources span all downlink AAI subframes for a Time Division Duplexing (TDD) scheme.

In Table 1, AI_SN represents a Hybrid Automatic Retransmission reQuest (HARQ) ID sequence number, and for example, may be implemented by using 1 bit. The AI_SN toggles whenever a new HARQ transmission is attempted by using the same HARQ Channel IDentifier (ACID). Therefore, when data packet transmission has succeeded, the value of the AI_SN changes from 0b0 to 0b1 or from 0b1 to 0b0.

In Table 1, Retransmission Interval represents a retransmission time interval for the next retransmission, and for example, may be implemented by using 2 bits. When the value of the Retransmission Interval is 0b00, the Retransmission Interval indicates that there is no retransmission of both a multicast data burst and a multicast resource allocation IE. When the value of the Retransmission Interval is 0b01, the Retransmission Interval indicates that the retransmission of both the multicast data burst and the multicast resource allocation IE is performed after 1 frame. When the value of the Retransmission Interval is 0b10, the Retransmission Interval indicates that the retransmission of both the multicast data burst and the multicast resource allocation IE is performed after 2 frames. When the value of the Retransmission Interval is 0b11, the Retransmission Interval indicates that the retransmission of both the multicast data burst and the multicast resource allocation IE is performed after 3 frames. Namely, the Retransmission Interval represents a time interval, during which both a relevant multicast data burst and a resource allocation IE (i.e. a multicast A-MAP IE) on multicast resources, through which the relevant multicast data burst is transmitted, are to be retransmitted.

In Table 1, ACID represents a HARQ buffer ID, and for example, may be implemented by using 2 bits.

In Table 1, a SubPacket ID (SPID) may be implemented by using 2 bits. The IEEE 802.16m communication system employs an Incremental Redundancy (IR) scheme, and when the IR scheme is employed, each subpacket includes a part of a codeword determined by the SPID. Also, the SPID circularly increases by 1 at each retransmission time.

In Table 1, a Constellation Rearrangement Version (CRV) may be implemented by using 1 bit. For example, when the IEEE 802.16m communication system employs a 16 Quadrature Amplitude Modulation (QAM) scheme or a 64QAM scheme as a modulation scheme, a single modulation symbol includes multiple bits. In this regard, a scheme for constellation rearrangement refers to a scheme for exchanging the locations of bits included in a single modulation symbol. Accordingly, the locations of the multiple bits included in the single modulation symbol are determined by the value of the CRV. The scheme for the constellation rearrangement will be briefly described hereinafter.

First, when the IEEE 802.16m communication system employs the 16QAM scheme, a single modulation symbol has a total of 4 bits including b0, b1, b2 and b3. For example, when the value of the CRV is 0b0, locations of the 4 bits included in the single modulation symbol are b0, b1, b2 and b3. When the value of the CRV is 0b1, locations of the 4 bits included in the single modulation symbol are b3, b2, b1 and b0.

Second, when the IEEE 802.16m communication system employs the 64QAM scheme, a single modulation symbol has a total of 6 bits including b0, b1, b2, b3, b4 and b5. For example, when the value of the CRV is 0b0, locations of the 6 bits included in the single modulation symbol are b0, b1, b2, b3, b4 and b5. When the value of the CRV is 0b1, locations of the 6 bits included in the single modulation symbol are b5, b4 b3, b2, b1 and b0.

Even though the multicast scheme is employed in exemplary embodiments of the present invention as described above, the HARQ scheme is employed to improve the reception performances of MSs. Therefore, a multicast resource allocation IE includes an AI_SN, an ACID, an SPID and a CRV.

Meanwhile, one of the characteristics of the multicast A-MAP IE is that there are no feedback channels for retransmission. Since the multicast A-MAP IE should be received by multiple MSs included in a relevant multicast group, the multiple MSs should be allocated feedback channels in order to receive feedback information from the multiple MSs. The number of feedback channels is equal to that of the multiple MSs, each of which should receive the multicast A-MAP IE.

However, when the MSs are allocated the feedback channels, each of which should receive the multicast A-MAP IE, the length of the multicast A-MAP IE becomes excessively long. Therefore, a BS notifies the MSs of a Retransmission Interval as described in Table 1. When the BS has notified the MSs of the Retransmission Interval as described above, a multicast A-MAP IE can be retransmitted to the MSs even when feedback information is not transmitted by the MSs.

Also, since the multicast A-MAP IE should be received by the MSs using the same group ID, a Multiple Input Multiple Output (MIMO) Encoder Format (MEF), for example, will be fixed as a Space-Frequency Block Code (SFBC). Further, since the multicast A-MAP IE includes a group ID, a group that is to receive the multicast A-MAP IE, can be designated by using the Group ID. When the multicast A-MAP IE is CRC-masked by using the group ID and then the CRC-masked multicast A-MAP IE is transmitted, each of the MSs can blind-decode all of the received multicast A-MAP IEs by using the group ID of each MS itself.

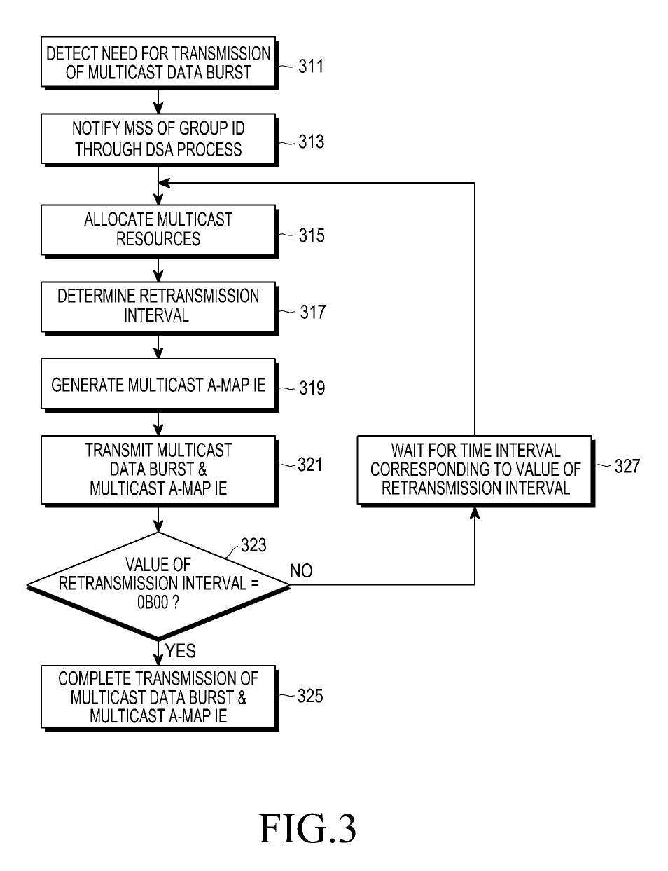

Next, an operations process of a BS in the IEEE 802.16m communication system according to the exemplary embodiment of the present invention will be described with reference to FIG. 3.

FIG. 3 is a flowchart showing an operational process of a BS in the IEEE 802.16m communication system according to the exemplary embodiment of the present invention.

Referring to FIG. 3, in step 311, when the BS has detected a need for the transmission of a multicast data burst, it proceeds to step 313. In step 313, the BS determines a group that is to receive the multicast data burst, notifies MSs that are included in the group of a group ID of the group through a DSA process, and then proceeds to step 315. However, the present invention is not limited thereto, and suitable notification processes, other than the DSA process, may be used.

In step 315, the BS allocates multicast resources through which the multicast data burst is to be transmitted, and then proceeds to step 317. In step 317, the BS determines a Retransmission Interval of the MSs included in the determined group, and then proceeds to step 319. Namely, in step 317, the BS determines a Retransmission Interval representing a time interval during which both the multicast data burst and a resource allocation IE (i.e. a multicast A-MAP IE) on the multicast resources are to be retransmitted. The determination is made by using various parameters, including a Channel Quality Indicator (CQI) distribution of the MSs included in the determined group, a Quality of Service (QoS) of the multicast data burst, or other similar parameters.

In step 319, the BS generates a multicast A-MAP IE, and then proceeds to step 321. Herein, the generated multicast A-MAP IE is the same as described above with reference to Table 1, and thus a detailed description thereof will be omitted. In step 321, the BS transmits the multicast data burst and the multicast A-MAP IE to each of the MSs, and then proceeds to step 323. In step 323, the BS determines whether the value of the Retransmission Interval is 0b00. Herein, the reason why the BS determines whether the value of the Retransmission Interval is 0b00 is to determine whether the BS should retransmit the multicast data burst and the multicast A-MAP IE.

When a result of the determining in step 323 shows that the value of the Retransmission Interval is 0b00, the BS proceeds to step 325. In step 325, since the value of the Retransmission Interval is 0b00, the BS detects that there is no need for the retransmission of both the multicast data burst and the multicast A-MAP IE. Therefore, the BS completes the transmission of both a multicast data burst and a multicast A-MAP IE.

On the other hand, when the result of the determining in step 323 shows that the value of the Retransmission Interval is not 0b00, the BS proceeds to step 327. In step 327, the BS waits for a time interval corresponding to the value of the Retransmission Interval, and then proceeds to step 315. In step 315, the BS performs the allocation of multicast resources through which the multicast data burst is to be retransmitted, and then performs the following steps again. Herein, the reason why the BS waits for the time interval corresponding to the value of the Retransmission Interval is that the BS should retransmit the multicast data burst and the multicast A-MAP IE at the end of one or more frames corresponding to the value of the Retransmission Interval.

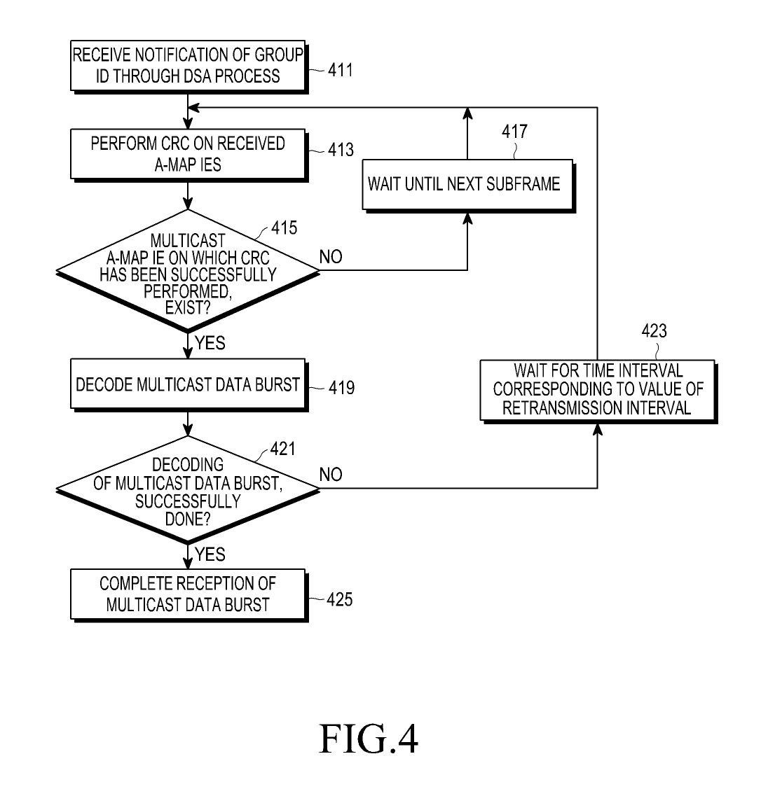

Next, an operations process of an MS in the IEEE 802.16m communication system according to the exemplary embodiment of the present invention will be described with reference to FIG. 4.

FIG. 4 is a flowchart showing an operational process of an MS in an IEEE 802.16m communication system according to the exemplary embodiment of the present invention.

Referring to FIG. 4, in step 411, the MS is notified of a group ID of a group including the MS through a DSA process, and then proceeds to step 413. In step 413, the MS is allocated multicast resources according to the reception of the notification of the group ID so that the MS may receive a multicast A-MAP IE. Accordingly, in step 413, the MS performs a CRC on the received A-MAP IEs by using the group ID, and then proceeds to step 415. Herein, the multicast A-MAP IE is similar to a multicast A-MAP IE described in Table 1, and thus a detailed description thereof will be omitted.

In step 415, the MS determines whether there is a multicast A-MAP IE on which the CRC has been successfully performed. When a result of the determining in step 415 shows that there is no multicast A-MAP IE on which the CRC has been successfully performed, the MS proceeds to step 417. In step 417, the MS waits until the next subframe, and then proceeds to step 413.

On the other hand, when the result of the determining in step 415 shows that there is a multicast A-MAP IE on which the CRC has been successfully performed, the MS proceeds to step 419. In step 419, the MS receives a multicast data burst in response to the multicast A-MAP IE on which the CRC has been successfully performed, decodes the received multicast data burst, and then proceeds to step 421. In step 421, the MS determines whether the decoding of the multicast data burst has succeeded.

When a result of the determining in step 421 shows that the decoding of the multicast data burst has failed, the MS proceeds to step 423. In step 423, the MS waits for a time interval corresponding to the value of a Retransmission Interval included in the multicast A-MAP IE, and then proceeds to step 413. At this time, if the value of the Retransmission Interval is 0b0, the multicast data burst and the multicast A-MAP IE are not retransmitted. Therefore, in step 423, the MS directly proceeds to step 413 without waiting for a time interval.

On the other hand, when the result of the determining in step 421 shows that the decoding of the multicast data burst has succeeded, the MS proceeds to step 425. In step 425, the MS completes the reception of a multicast data burst. Namely, in step 425, the MS no longer receives a multicast data burst, since the decoding of the relevant multicast data burst has already succeeded even though a multicast A-MAP IE indicating an ACID equal to an ACID of the successfully decoded multicast data burst is retransmitted.

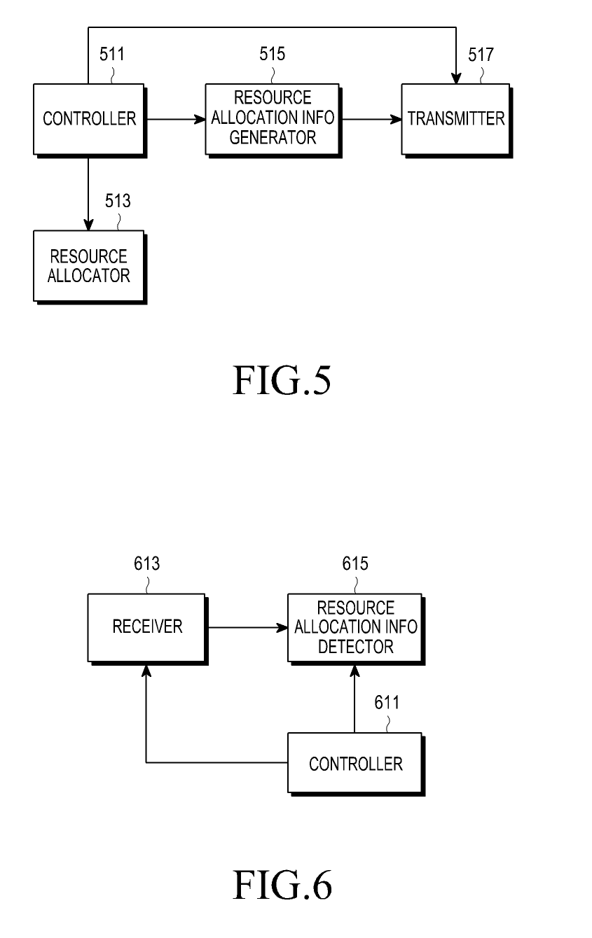

Next, an internal configuration of a BS in the IEEE 802.16m communication system according to the exemplary embodiment of the present invention will be described with reference to FIG. 5.

FIG. 5 is a block diagram illustrating an internal configuration of a BS in the IEEE 802.16m communication system according to the exemplary embodiment of the present invention.

Referring to FIG. 5, the BS includes a controller 511, a resource allocator 513, a resource allocation information generator 515, and a transmitter 517.

The controller 511 controls an overall operation of the BS. The resource allocator 513 performs the allocation of multicast resources under the control of the controller 511.

The resource allocation information generator 515 generates a multicast A-MAP IE, which corresponds to resource allocation information, under the control of the controller 511. Herein, an operation of the resource allocation information generator 515 for generating a multicast A-MAP IE on multicast resources allocated to a group is similar to the operation described above with reference to FIG. 3, and thus a detailed description thereof will be omitted. Also, the transmitter 517 transmits the multicast A-MAP IE generated by the resource allocation information generator 515. Therefore, the BS serves as a transmission apparatus for transmitting a multicast A-MAP IE.

The controller 511, the resource allocator 513, the resource allocation information generator 515 and the transmitter 517 are implemented as separate elements as illustrated in FIG. 5. However, the present invention is not limited thereto, and any number of the controller 511, the resource allocator 513, the resource allocation information generator 515 and the transmitter 517 can be implemented as an integrated single unit.

Next, an internal configuration of an MS in the IEEE 802.16m communication system according to the exemplary embodiment of the present invention will be described with reference to FIG. 6.

FIG. 6 is a block diagram illustrating an internal configuration of an MS in the IEEE 802.16m communication system according to an exemplary embodiment of the present invention.

Referring to FIG. 6, the MS includes a controller 611, a receiver 613, and a resource allocation information detector 615.

The controller 611 controls an overall operation of the MS. The receiver 613 performs a process for receiving a signal from the BS, and then provides the reception-processed signal to the resource allocation information detector 615. The resource allocation information detector 615 detects a multicast A-MAP IE from the signal provided by the receiver 613. Herein, an operation of the resource allocation information detector 615 is similar to the operations described above with reference to FIG. 4, and thus a detailed description thereof will be omitted. Therefore, the MS serves as a reception apparatus for receiving a multicast A-MAP IE.

The controller 611, the receiver 613, and the resource allocation information detector 615 are implemented as separate elements as illustrated in FIG. 6. However, the present invention is not limited thereto, and any number of the controller 611, the receiver 613, and the resource allocation information detector 615 can be implemented as an integrated single unit.

According to exemplary embodiments of the present invention, it is possible to at least one of transmit and receive resource allocation information on multicast resources in an IEEE 802.16m communication system. By enabling the at least one of transmission and reception of the multicast resource allocation information as described above, when a multicast data burst is transmitted in a multicast scheme, resource allocation information on multicast resources can be transmitted on the basis of a group that includes each of the MSs that should receive the multicast data burst. Accordingly, the multicast resources are transmitted to the group instead of to each of MSs which should receive the multicast data burst. The multicast data burst is to be transmitted through the multicast resources. Therefore, it is possible to minimize a signaling overhead for at least one of transmitting and receiving the multicast resource allocation information caused by the transmission of the multicast data burst and also to minimize resources necessary to at least one of transmit and receive the multicast resource allocation information. Accordingly, it is possible to increase resource efficiency.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for transmitting multicast resource allocation information by a base station in a communication system, the method comprising:
transmitting, to at least one mobile station, the multicast resource allocation information,
wherein the multicast resource allocation information comprises:
a Group IDentifier (ID) of a group receiving multicast resource allocation information on multicast resources through which a multicast data burst is to be transmitted,
a Resource Index indicating a location and a size of allocated multicast resources, and
a Long Transmission Time Interval Indicator (Long_TTI_Indicator) indicating a number of Advanced Air Interface (AAI) subframes spanned by the allocated multicast resources.

2. The method as claimed in claim 1, wherein the multicast resource allocation information further comprises an Advanced MAP Information Element (A-MAP IE) Type representing a type of an A-MAP IE used to transmit the multicast resource allocation information.

3. The method as claimed in claim 1, wherein the Long_TTI_Indicator comprises:
a first value indicating that the number of AAI subframes spanned by the allocated multicast resources is equal to a first number; and
a second value indicating that the number of AAI subframes spanned by the allocated multicast resources is equal to a second number or a third number,
wherein the second number represents a number of DownLink (DL) AAI subframes for a Frequency Division Duplexing (FDD) scheme, and
the third number represents a number of all DL AAI subframes for a Time Division Duplexing (TDD) scheme.

4. The method as claimed in claim 2, further comprising:
detecting a multicast data burst to be transmitted from the base station to the at least one mobile station;
notifying the at least one mobile station of the Group ID through a Dynamic Service Addition (DSA) process;
allocating the multicast resources according to the at least one mobile station of the group receiving the multicast resource allocation information;
determining a retransmission interval having a time interval during which the multicast data burst and the A-MAP IE are retransmitted; and
generating the A-MAP IE to be transmitted to the at least one mobile station.

5. The method as claimed in claim 1, further comprising transmitting the multicast data burst along with the multicast resource allocation information.

6. A method for receiving multicast resource allocation information by a mobile station in a communication system, the method comprising:
receiving, from a base station, the multicast resource allocation information,
wherein the multicast resource allocation information comprises:
a Group IDentifier (ID) of a group receiving multicast resource allocation information on multicast resources through which a multicast data burst is to be transmitted,
a Resource Index indicating a location and a size of allocated multicast resources, and
a Long Transmission Time Interval Indicator (Long_TTI_Indicator) indicating a number of Advanced Air Interface (AAI) subframes spanned by the allocated multicast resources.

7. The method as claimed in claim 6, wherein the multicast resource allocation information comprises an Advanced MAP Information Element (A-MAP IE) Type representing a type of an A-MAP IE used to transmit the multicast resource allocation information.

8. The method as claimed in claim 6, wherein the Long_TTI_Indicator comprises:
a first value indicating that the number of AAI subframes spanned by the allocated multicast resources is equal to a first number; and
a second value indicating that the number of AAI subframes spanned by the allocated multicast resources is equal to a second number or a third number,
wherein the second number represents a number of DownLink (DL) AAI subframes for a Frequency Division Duplexing (FDD) scheme, and
the third number represents a number of all DL AAI subframes for a Time Division Duplexing (TDD) scheme.

9. The method as claimed in claim 7, further comprising:
receiving notification of the Group ID through a Dynamic Service Addition (DSA) process;
performing a Cyclic Redundancy Check (CRC) on the received A-MAP IE; and
determining whether the CRC has been successfully performed on the received A-MAP IE.

10. The method as claimed in claim 9, further comprising:
decoding the received multicast data burst corresponding to the A-MAP IE having a successfully performed CRC; and
waiting until a next subframe to receive another A-MAP IE.

11. The method as claimed in claim 10, further comprising:
determining whether the decoding of the received multicast data burst has been successfully performed; and
waiting for a retransmission interval to expire in order to receive another A-MAP IE if the decoding of the multicast data burst was not successfully performed,
wherein the retransmission interval is a time interval during which the multicast data burst and the A-MAP IE are retransmitted.

12. A base station in a communication system, the base station comprising:
a signal generator for generating multicast resource allocation information; and
a transmitter for transmitting the multicast resource allocation information,
wherein the multicast resource allocation information comprises:
a Group IDentifier (ID) of a group receiving multicast resource allocation information on multicast resources through which a multicast data burst is to be transmitted,
a Resource Index indicating a location and a size of allocated multicast resources, and
a Long Transmission Time Interval Indicator (Long_TTI_Indicator) indicating a number of Advanced Air Interface (AAI) subframes spanned by the allocated multicast resources.

13. The base station as claimed in claim 12, wherein the multicast resource allocation information comprises an Advanced MAP Information Element (A-MAP IE) Type representing a type of an A-MAP IE used to transmit the multicast resource allocation information.

14. The base station as claimed in claim 12, wherein the Long_TTI_Indicator comprises:
a first value indicating that the number of AAI subframes spanned by the allocated multicast resources is equal to a first number; and
a second value indicating that the number of AAI subframes spanned by the allocated multicast resources is equal to a second number or a third number,
wherein the second number represents a number of DownLink (DL) AAI subframes for a Frequency Division Duplexing (FDD) scheme, and
the third number represents a number of all DL AAI subframes for a Time Division Duplexing (TDD) scheme.

15. The base station as claimed in claim 12, further comprising:
a resource allocator for allocating the multicast resources to the group receiving the multicast resource allocation information; and
a controller for controlling the signal generator, the transmitter and the resource allocator.

16. A mobile station in a communication system, the mobile station comprising:
a receiver for receiving multicast resource allocation information; and
a resource allocation information detector for detecting the multicast resource allocation information,
wherein the multicast resource allocation information comprises:
a Group IDentifier (ID) of a group receiving multicast resource allocation information on multicast resources through which a multicast data burst is to be transmitted,
a Resource Index indicating a location and a size of allocated multicast resources, and
a Long Transmission Time Interval Indicator (Long_TTI_Indicator) indicating a number of Advanced Air Interface (AAI) subframes spanned by the allocated multicast resources.

17. The mobile station as claimed in claim 16, wherein the multicast resource allocation information comprises an Advanced MAP Information Element (A-MAP IE) Type representing a type of an A-MAP IE used to transmit the multicast resource allocation information.

18. The mobile station as claimed in claim 16, wherein the Long_TTI_Indicator comprises:
a first value indicating that the number of AAI subframes spanned by the allocated multicast resources is equal to a first number; and
a second value indicating that the number of AAI subframes spanned by the allocated multicast resources is equal to a second number or a third number,
wherein the second number represents a number of DownLink (DL) AAI subframes for a Frequency Division Duplexing (FDD) scheme, and
the third number represents a number of all DL AAI subframes for a Time Division Duplexing (TDD) scheme.

19. The mobile station as claimed in claim 16 further comprising a controller for controlling the receiver and the resource allocation information detector.
